(19) United States
(12) Patent Application Publication
(10) Pub. No.: US 2011/0213735 A1
(43) Pub. Date: Sep. 1, 2011

(54) Selecting An Installation Rack For A Device In A Data Center

(75) Inventors: Yu Zhong Cao, Beijing (CN); Li Wang, Beijing (CN); Yi Ming Yin, Shanghai (CN)

(73) Assignee: INTERNATIONAL BUSINESS MACHINES CORPORATION, Armonk, NY (US)

(21) Appl. No.: 13/032,963

(22) Filed: Feb. 23, 2011

(30) Foreign Application Priority Data
Feb. 26, 2010 (CN) 201010117761.7

(51) Int. Cl. G06Q 90/00

(52) U.S. Cl. 705/500

(57) ABSTRACT

Selecting an installation rack for a device in a data center including obtaining physical size and power of the device; judging, according to the physical size and power of the device, whether rack space, rack total power, and rack unit power density of a rack in the data center satisfy predetermined requirement after the device is added into the rack; and selecting a rack that satisfies the predetermined requirement as an installation rack.

### CLAIM OF PRIORITY

This application claims priority under 35 U.S.C §119 to Chinese Patent Application No. 201010117761.7 filed Feb. 26, 2010, the entire text of which is specifically incorporated by reference herein.

### BACKGROUND OF THE INVENTION

1. Field of the Invention

The field of the invention is data processing, or, more specifically, methods and systems for selecting an installation rack for a device in a data center.

2. Description of Related Art

There are hundreds and thousands of racks in a large data center, and various IT devices are installed in the racks. In general, spaces on these racks are not used completely. The unused space means waste in investment. Many enterprises have to build a new data center every few years merely because they can not find suitable rack space in existing data center to place new devices.

Cooling of data center mainly relies on cold air outputted through air condition equipment, cold air ingresses air inlets of various IT devices in a rack via cold channel in data center, carries away heat emitted from inside of IT devices, and becomes into hot air that is discharged from air outlets of various IT devices. After such hot air is discharged to hot channel of data center, it needs to flow back to air condition equipment by which hot air is cooled again. If total power (total power consumption) of various IT devices disposed in a rack is too high, a large amount of heat will be emitted, which may exceed cooling capability provided by cooling facility equipped in data center, such that heat emitted by devices in this rack can not be discharged completely, the hot air that can not be discharged forms hot spot in data center which may threaten normal operation of IT devices around the hot spot. Meanwhile, hot air aggregated in local hot spot will penetrate towards cold channel, and will heat cold air in cold channel, thereby significantly influencing cooling efficiency of air condition, data center has to increase power of existing air condition or add new air condition to provide more cold air. As indicated by data of US Department of Energy that, in 2007, percentage of total power consumption of all US's data centers over total power consumption of entire US has already exceeded 2%, and percentage of power consumption of air condition devices over total power consumption of data center is typically about 50%. It can be imagined that, presence of local hot spots in data center significantly influences cooling efficiency of air condition and brings about huge energy waste.

Rack space utilization and rack total power are in contradiction to each other. Investor always wants to place more IT devices in a rack, provide more computing capability, and make space utilization of the rack as high as possible. Meanwhile, if too many IT devices are disposed in a rack, total power of this rack will be too high, and in turn it needs to be considered whether cooling capability of air condition is sufficient and whether the emitted heat can be carried away in time. For example, if an industry standard 42 U rack is fully filled by forty-two 1 U servers, total power consumption of this rack may reach 20 KW to 40 KW and the emitted heat is far beyond cooling capability of air condition wind cooling normally used in data center.

Further, rack space utilization and rack total power are not always in linear correspondence relationship. For example, if there are four 8 U servers in rack A and power of each server is 1500 W, space used in rack A is 32 U and total power is 6000 W; if there are sixteen 1 U servers in rack B and power of each server is 500 W, space used in rack B is 16 U and total power is 9000 W; it can be seen that, although space utilization of rack A is much higher than that of rack B, total power of rack A is still lower than that of rack B. With such non-linear correspondence relationship between rack space utilization and rack total power, it is more difficult for administrator of data management center to control space utilization and heat dissipation problem of each rack in data center, there is always such a case that one thing is considered but another is neglected.

Underutilized rack space and hot spot problems are very common in current data center management. There are already some technologies attempting to help administrator of data center to solve these problems. These existing technologies include: displaying device position and free space on each rack in data center in a visualized view by using a visualized data center rack space planning tool, so that administrator of data center may quickly find free space to place new device; using temperature monitoring tool to collect temperature data in data center environment by wireless sensors and then generate a three-dimensional temperature map. Presence of hot spots in data center can be seen from the map. Such tool can monitor hot spots then administrator can try to eliminate hot spots by changing ventilation capability of cold and hot channels by later adjustment (such as movement of device), and increasing cooling capability.

In the prior art, there also exists advanced IBM MMT (IBM Mobile Measurement Technology), which can measure temperature, airflow, air pressure, ventilation quantity of cold air and other data at each point in space of data center, generate a three-dimensional temperature map, air pressure and airflow simulated diagram, indicate hot spots in data center, and indicate, through analysis, places in data center where airflow, air pressure, and ventilation quantity of cold air etc need to be adjusted to improve overall cooling efficiency. In general, by MMT's measurement, analysis and by taking corresponding device adjustment, energy consumption of overall data center may be reduced by 10%-20%.

In the prior art, there is also IBM's water cooling backplane technology, which can quickly take away heat generated by devices in rack by means of water circulation system in backplane of the rack. Since efficiency of water cooling is much higher than air conditioning, a rack equipped with water cooling backplane may have very high total power and there is substantially no need to worry about heat dissipation problem. The water cooling backplane technology needs additional investment and generally not every rack in data center is equipped with such technology, thus, there is more need for administrator to consider and handle the problem that cooling capabilities of various racks are not balanced, and attempt to improve space utilization of each rack while keep the power consumption of each rack in an appropriate range to well meet the cooling capabilities.

All of the above technologies just focus on monitoring or adjusting afterward, but are not able to manage and improve rack space utilization during data center planning and before the problem occurs. The prior arts can not estimate the overall impact on the whole data center and can not advise whether there is a better place to place a device before a device is truly placed at a specific rack location. Also, all of the above technologies only focus on solving one problem: either improving rack space utilization; or solving heat dissipation problem. Currently, there is no method to synthetically solve these two problems.

Thus, there is a need for a method and system of managing and improving rack space utilization before a problem occurs, which can improve rack space utilization in data center as high as possible while ensuring that the total power consumption of each rack is within an optimized range, so as to meet the cooling capability.

### SUMMARY OF THE INVENTION

Methods and systems for selecting an installation rack for a device in a data center are disclosed in this specification. Selecting an installation rack in accordance with embodiments of the present invention includes obtaining physical size and power of the device; judging, according to the physical size and power of the device, whether rack space, rack total power, and rack unit power density of a rack in the data center satisfy predetermined requirement after the device is added into the rack; and selecting a rack that satisfies the predetermined requirement as an installation rack.

Methods and systems for evaluating risk in a data center upon device installation in a rack are disclosed in this specification. Evaluating risk upon device installation in accordance with embodiments of the present invention includes obtaining physical size and power of the device; judging whether rack total power, and rack unit power density satisfy a predetermined requirement when the device is in the current rack according to physical size and power of the device; and determining that there is risk when the device is installed in the current rack, if any one of rack total power or rack unit power density does not satisfy the predetermined requirement.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a flow chart illustrating an example method of selecting an installation rack for a device in a data center in accordance with embodiments of the present invention.

FIG. 2 sets forth a flow chart illustrating an example method of judging whether rack space, rack total power and rack unit power density of a rack satisfy predetermined requirement after the device is added into the rack in accordance with embodiments of the present invention.

FIG. 3 sets forth a flow chart illustrating a further example method of judging whether rack space, rack total power and rack unit power density of a rack satisfy predetermined requirement after the device is added into the rack in accordance with embodiments of the present invention.

FIG. 4 sets forth a flow chart illustrating a method evaluating in a data center whether there is risk when a device is installed in a rack in accordance with embodiments of the present invention.

FIG. 5 sets forth a block diagram of an example system for selecting an installation rack for a device in a data center in accordance with embodiments of the present invention.

FIG. 6 sets forth a block diagram of an example system for evaluating in a data center whether there is risk when a device is installed in a current rack.

### DETAILED DESCRIPTION OF EXEMPLARY EMBODIMENTS

Methods and systems of selecting an installation rack for a device in a data center in accordance with embodiments of the present invention will be described in detail with reference to the drawings. However, the methods and systems set forth in the drawing should not be construed as limiting.

A data center administrator may lack overall control on space utilization of many racks and total power of respective rack in data center as well as the required cooling capability, for example, administrator of data center may face such problems: (1) how to find a rack having sufficient free space to place therein a new device; (2) if a rack is selected to place therein this new device, then after the placement, whether total power of this rack will exceed capacity, including after the new device is added into the rack, whether the amount of heat emission will be too high, thereby generating hot spots; (3) if there are free space on multiple racks simultaneously to place therein the new device, which rack is more suitable to place the device, that is, by synthetically considering from the perspective of rack space and heat dissipation, which rack is advantageous for further placing therein new machines in the future and improving overall rack space utilization of entire data center; (4) cooling capability of respective region in data center is not always equal, for example, for rack A, it is suitable for placing therein a set of devices having total power of 10 KW, because cooling capability of the region is sufficient, no hot spot will be generated. However, for rack B, it is only suitable for placing therein a set of devices having total power of 8 KW; and hot spot will be generated if devices having total power of 10 KW are placed in rack B. Thus, a problem to be solved is: how to consider and fully utilize unbalance in rack cooling capability when a new machine is placed.

The invention proposes a method and system of managing and improving rack space utilization. The method and system of the invention can help administrator of data center to find preferred rack location for placing device, in stage of data center planning, placement of new device, or in stage of relocation of existing devices, such as, in stage of moving existing device to another rack location, thereby improving space utilization of each rack in data center, and avoiding hot spots since total power of devices on each rack complies with cooling capability for that rack. Also, the method and system of the invention may also be used for monitoring and analyzing risk of existing rack on space utilization and heat dissipation capability.

As for one rack, when space utilization of that rack is high, it is likely that its rack power density is also very high, thereby resulting in hot spot which will impact cooling efficiency. The invention takes into account avoiding hot spots while improving rack space utilization as high as possible, so that to gain higher efficiency and lower risk during data center planning, and design.

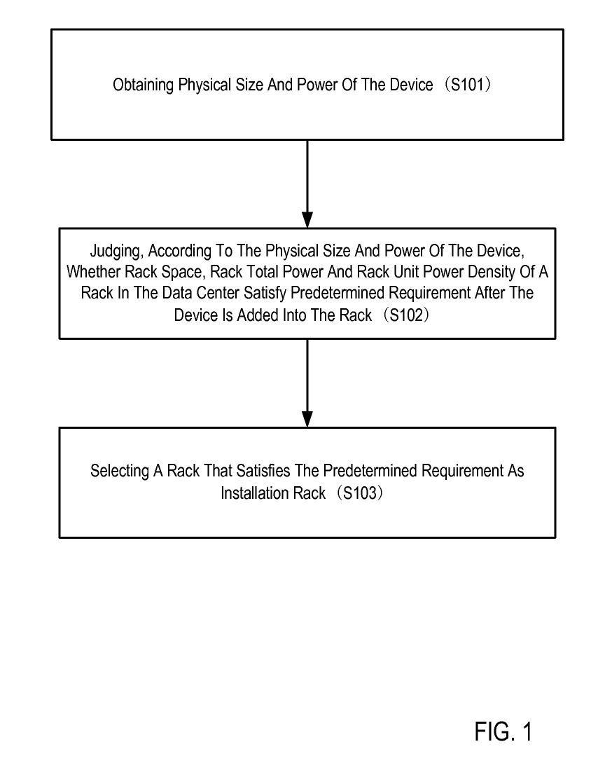

FIG. 1 shows a flow of a method of the invention of selecting an installation rack for a device in a data center, the method comprising: in step S101, obtaining physical size and power of the device; in step S102, judging, according to the physical size and power of the device, whether rack space, rack total power and rack unit power density of a rack in the data center satisfy predetermined requirement after the device is added into the rack; in step S103, selecting a rack that satisfies the predetermined requirement as an installation rack.

The method shown in FIG. 1 may help administrator of data center to design device placement in data center, including determine location of placing a new device and adjust location of an existing device.

First, for step S101, physical size of the device may be 1 U or any other measurement unit that may be used to measure a device, such as, unit of length, width, height, area, volume, for example, square foot, square meter, cube meter, centimeter and so on. Taking 1 U for example below, U in server refers to physical space unit occupied by server, refers to physical size of server, 1 U=4.445 centimeter. There are various types of device power, the available power includes: rated power, average power during actual operation and maximum power during actual operation. Rated power is also called as nameplate power, which is a power labeled on product or given in specification by manufacturer via test when the device is manufactured, and is normally much higher than device's actual operation power; average power during actual operation refers to actual power of the device during operation; maximum power during actual operation is instantaneous maximum power of the device during operation. In the present invention, average power during actual operation or maximum power during actual operation is preferably used to perform subsequent analysis. For an existing device, the parameters may be obtained from historical monitoring data of the system; for a new device, the parameters may be obtained by searching for historical monitoring data of a device with same type and same configuration; for a new device, if device of the same type has never been used in the present data center, subsequent analysis may be performed by first using rated power, and after the device has been operated for a period of time and corresponding monitoring data is acquired, analysis may then be performed again by using average power during actual operation and maximum power during actual operation obtained from monitoring data in actual operation, so as to acquire more accurate result.

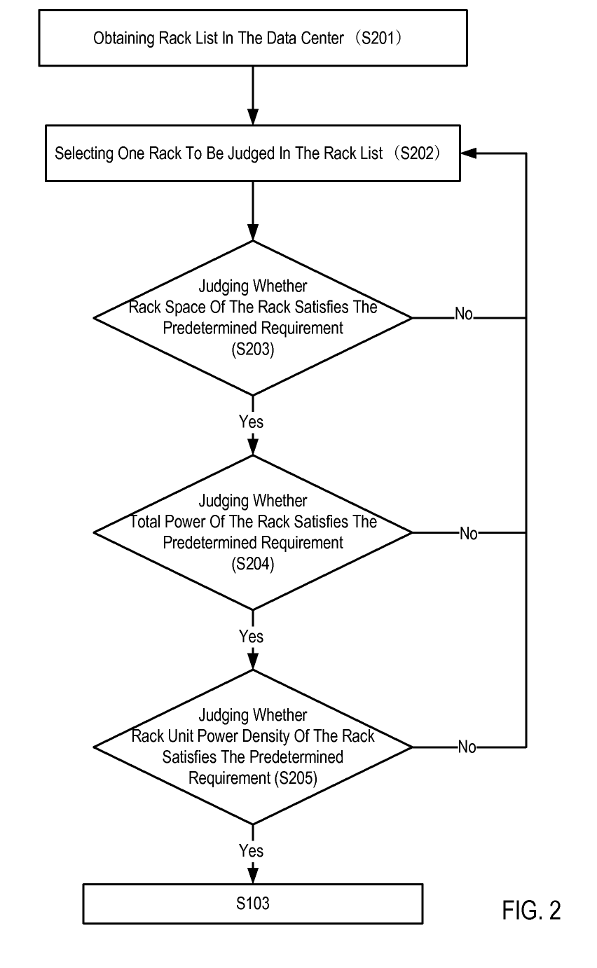

In particular, for step 102 in FIG. 1, the key of which is to judge whether rack space, rack total power and rack unit power density of the rack in data center satisfy a predetermined requirement after the device is added into that rack, as to which parameter is first judged, whether rack space or rack total power is first judged or rack unit power density is first judged is not important. Thus, there may be various embodiments. FIG. 2 illustratively shows a flow of one embodiment of step S102 in FIG. 1. The flow includes: in step S201, obtaining rack list in the data center; in step S202, selecting one rack to be judged in the rack list; in step S203, judging whether rack space of the rack satisfies the predetermined requirement, and returning to step S202 if rack space of the rack does not satisfy the predetermined requirement. Existing technology may be employed to judge whether rack space of the rack satisfies a requirement, that is, judge whether free space of the rack is sufficient to install the device. For example, if there is 1 U space remaining in rack and height of the device is 2 U, then free space of rack does not satisfy the requirement. In some embodiments, in predetermined requirement for rack space, it may be required to select a rack currently has the highest space utilization from the rack list. Selecting a rack currently has the highest space utilization to place new machine is advantageous for further improving rack space utilization. For example, a first rack has totally 42 U in which 30 U is used while a second rack has totally 42 U in which 20 U is used; then space utilization of the first rack is higher and should be selected preferentially. Of course, predetermined requirement on space also needs to be considered in conjunction with predetermined requirement of rack total power and predetermined requirement of rack unit power density. Other predetermined requirements on rack space are, for example: different regions are divided in data center, if the device is only to be placed in a specified region, it may be defined in predetermined requirement of rack space, or only racks in this region are placed into rack list. Further, if cooling capability of certain region in data center is redundant, and the device is to be preferably placed into this region, then it may be defined in predetermined requirement of rack space, or only racks in this region are placed into candidate rack list.

Step S204 includes judging whether rack total power of the rack satisfies the predetermined requirement, and returning to step S202 if rack total power of the rack does not satisfy the predetermined requirement. Predetermined requirement for rack total power includes: total power of all devices in a rack can not exceed maximum allowable total power of that rack. The maximum allowable total power of a rack is defined by powering load of the rack, powering load of powering line to which it belongs, and cooling capability that could be provided to the rack by air conditioner. In prior art, it mainly focuses on power defined by powering load, but power defined by rack cooling capability is not concerned. Besides constraint in powering load, each rack is also restricted by its cooling capability; total power of devices that may be placed therein can not exceed certain value, otherwise, cooling can not satisfy heat dissipation requirement and will result in hot spot. The maximum allowable total power of each rack in data center may be estimated beforehand. The maximum allowable total power of rack is restricted by two factors: powering load and rack cooling capability. Preferably, the minimum value of the maximum allowable total powers restricted by two factors may be taken as the maximum allowable total power of the rack. Wherein, the upper limit of powering load is fixed and does not need to be estimated, but certain method and tool are needed to estimate the maximum allowable total power restricted by rack cooling capability. There are various ways of estimating power restricted by rack cooling capability, and some are briefly introduced herein: (1) it is estimated according to cooling capability of respective region planned and implemented by the data center; (2) it is estimated according to historical monitoring data, including total power of respective rack during actual operation and temperature around respective rack; (3) it is estimated according to number of air outlet floor, ventilation quantity, air pressure, computational fluid dynamics (CFD) simulated result at air inlet of cold channel of respective rack measured by IBM mobile measurement technology.

Step S205 includes judging whether rack unit power density of the rack satisfies the predetermined requirement, and returning to step S202 if rack unit power density of the rack does not satisfy the predetermined requirement. The rack unit power density is power of device in unit of height within a rack, i.e., power consumption of device in unit of height within a rack. Since height of device is generally represented by U, unit power density of a device equals to total power of the device divided by height of the device (how many U); to expand this concept, unit power density of a rack equals to total power of all devices in the rack divided by number of Us of the rack which has been used, for example, 8 U devices are housed in a rack, total power of these devices are 16 KW, then rack power density of this rack is 2 KW/U; unit power density of certain region in data center equals to total power of all devices in this region divided by the sum of height of these devices (how many U); unit power density of overall data center equals to total power of all devices in data center divided by the sum of height of these device (how many U), for example, there are 3 racks in a data center, these racks consume 5 KW, 6 KW and 7 KW respectively, device height on each rack is 6 U, then power density of the data center is 1 KW/U.

Predetermined requirement for rack unit power density may be: the unit power density of a selected rack should be approaching the unit power density of the whole data center after the device is placed into the rack, or approaching the unit power density of a certain cooling region, or approaching a certain specified value, for example, this value may be specified by system administrator of data center. As for certain specified value, it refers to that, if the selected rack uses special cooling method such as water cooling backplane technology, it can allow higher total power, then predetermined requirement for rack unit power density may allow the unit power density of the rack into which the device is added to approach a certain value, rather than approaching the unit power density of the whole data center or the unit power density of a certain specified cooling region. This can handle the problem that cooling capabilities between racks are unbalanced. Thus, the above three unit power density values herein will be collectively referred to as predetermined unit power density value. In one embodiment, predetermined requirement of rack unit power density may also be one of the following:

(1) Unit power density of the device is larger than a predetermined unit power density value, and unit power density of the selected rack is smaller than the predetermined unit power density value. In this case, it is considered that the rack satisfies predetermined requirement of rack unit power density. After the device is placed into the rack, unit power density of the rack may be enhanced so as to approach predetermined unit power density value; or
(2) Unit power density of the device is smaller than a predetermined unit power density value, and unit power density of the selected rack is larger than the predetermined unit power density value. In this case, it is considered that the rack satisfies predetermined requirement of rack unit power density. After the device is placed into the rack, unit power density of the rack may be reduced so as to approach predetermined unit power density value.

However, in other cases, it is considered that the rack does not satisfy predetermined requirement of rack unit power density, for example, if unit power density of the device is larger than a predetermined unit power density value, and unit power density of the selected rack is also larger than the predetermined unit power density value, then it is considered that the rack does not satisfy predetermined requirement of rack unit power density; alternatively, if unit power density of the device is smaller than a predetermined unit power density value, and unit power density of the selected rack is also smaller than the predetermined unit power density value, then it is considered that the rack does not satisfy predetermined requirement of rack unit power density etc.

The order of steps S203, S204 and S205 in FIG. 2 may be changed arbitrarily.

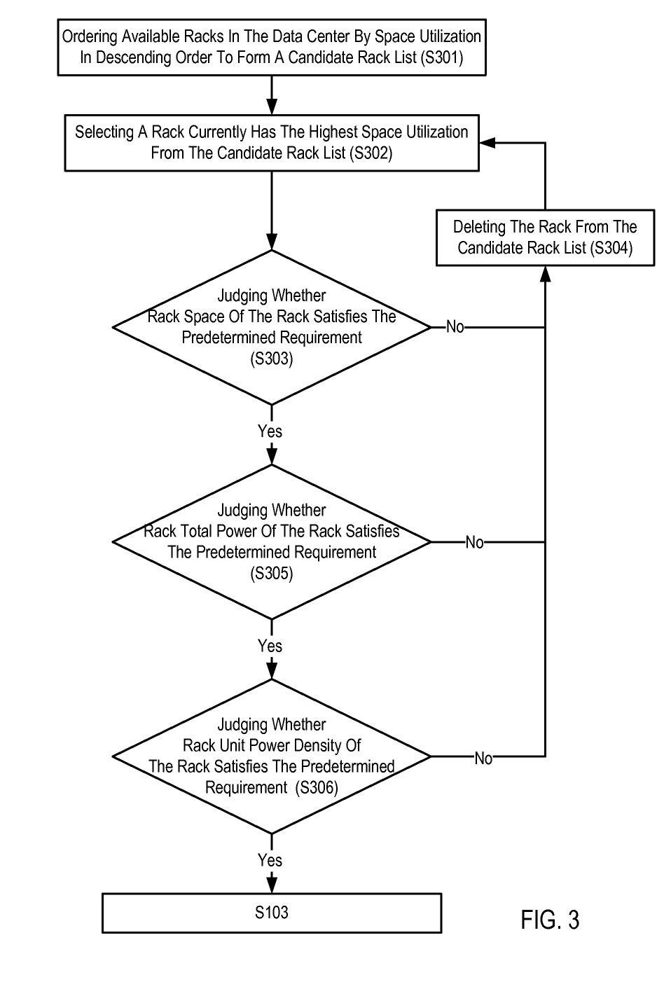

FIG. 3 illustratively shows a flow of another preferred embodiment of step 102 in FIG. 1. The flow set forth in FIG. 3 includes, in step S301, ordering available racks in the data center by space utilization to form a candidate rack list. For example, here the racks can be ordered in descending order in terms of their space utilization, in ascending order in terms of their space utilization, and so on.

Step s302 includes selecting a rack currently has the highest space utilization from the candidate rack list. Step S303 includes judging whether rack space of the selected rack satisfies the predetermined requirement. Step S304 includes deleting the rack from the candidate rack list and the method continues by returning to step S302 if rack space of the rack does not satisfy the requirement.

Step S305 includes judging whether rack total power of the rack satisfies the predetermined requirement and step S304 includes deleting the rack from the candidate rack list and returning to step S302 if rack total power of the rack does not satisfy the predetermined requirement.

Step S306 includes judging whether rack unit power density of the rack satisfies the predetermined requirement, and step S304 includes deleting the rack from the candidate rack list and returning to step S302 if rack unit power density of the rack does not satisfy the predetermined requirement.

The order of steps S303, S305 and S306 in FIG. 3 may be changed arbitrarily, and detailed method for judging whether rack space, rack total power and unit power density of the rack satisfy the predetermined requirement are the same as the judging methods in FIG. 2 and will be omitted.

A variety of variations to the method may also be derived from combination of FIG. 2 and FIG. 3, for example, rack with insufficient free space may first be filtered out and the remaining racks will form candidate racks, then it is judged one by one whether rack total power and rack unit power density satisfy predetermined requirement; alternatively, the filtering is first performed by using rack total power and rack unit power density etc, all these variations are within protection scope of the invention.

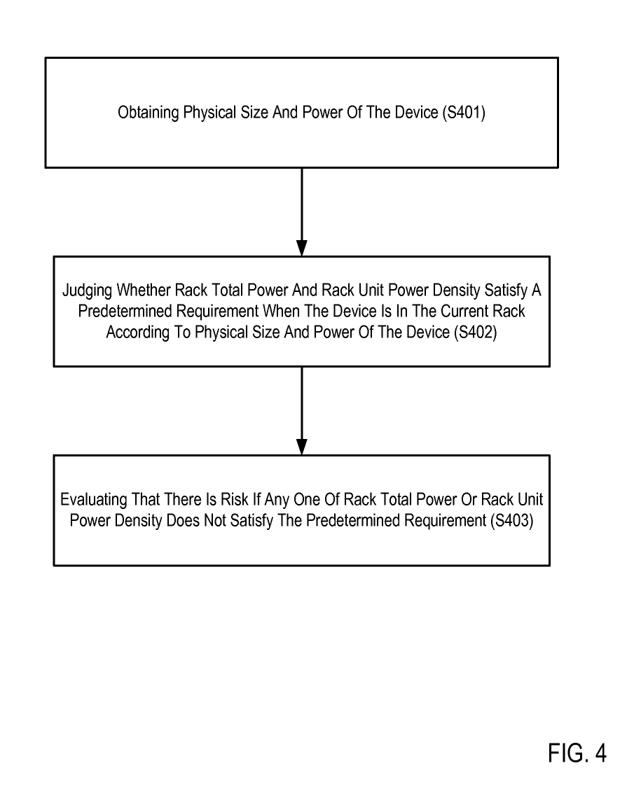

Under a same inventive conception, the invention also discloses a flow of a method of evaluating in a data center whether there is risk when a device is installed in a current rack, the method is shown in FIG. 4, comprising: in step S401, obtaining physical size and power of the device; in step S402, judging whether rack total power and rack unit power density satisfy a predetermined requirement when the device is in the current rack according to physical size and power of the device; and, in step S403, evaluating that there is risk when the device is installed in the current rack, if any one of rack total power or rack unit power density does not satisfy the predetermined requirement.

The detailed judging method is the same as that in FIG. 2 and will be omitted. When it is found that there is risk in placement location of certain device, it can be automatically indicated that certain existing device needs to be re-disposed to a new rack location, and the new suitable location is obtained by using the method shown in FIG. 1 and is prompted to administrator of the data center.

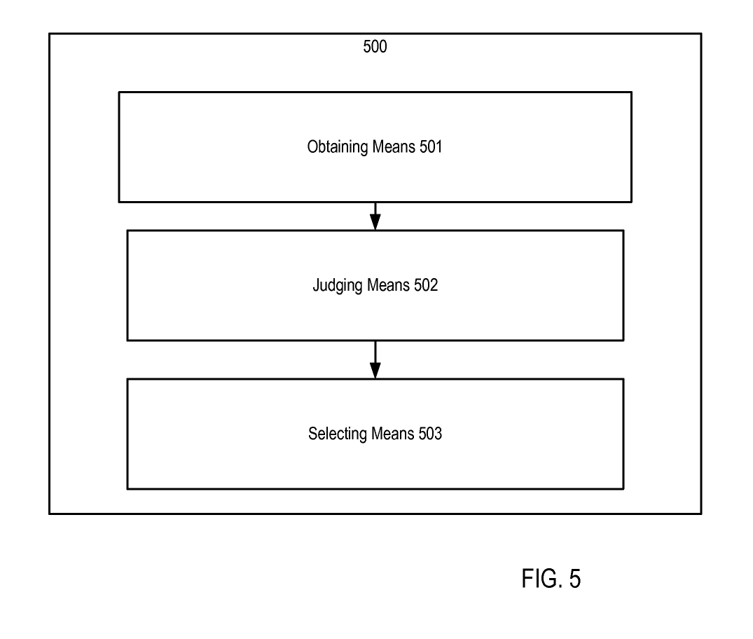

FIG. 5 sets forth a block diagram of an example system 500 for selecting an installation rack for a device in a data center, block diagram of the system is shown in FIG. 5, the system comprising: obtaining means 501 for obtaining physical size and power of the device; judging means 502 for judging, according to the physical size and power of the device, whether rack space, rack total power and rack unit power density of a rack in the data center satisfy predetermined requirement after the device is added into the rack; and selecting means 503 for selecting a rack that satisfies the predetermined requirement as an installation rack.

In the system shown in FIG. 5, the power of the device is rated power, average power during actual operation or maximum power during actual operation of the device. The average power during actual operation and the maximum power during actual operation of the device may be obtained from historical monitoring data; or be obtained by searching for historical monitoring data of a device with same type and same configuration; if they can not be obtained by any of the above methods, rated power may first be used, and after the device has been operated for a period of time and corresponding monitoring data is acquired, average power during actual operation and maximum power during actual operation may then be obtained from monitoring data.

In the system shown in FIG. 5, the judging means only needs to judge whether rack space, rack total power and rack unit power density of the rack satisfy the predetermined requirement, as to which parameter is first judged, whether rack space or rack total power is first judged or rack unit power density is first judged is not important. Thus, there may be various embodiments.

In a preferred embodiment, the judging means 502 of FIG. 5 comprises (not shown in FIG. 5): rack list obtaining means for obtaining rack list in the data center; rack selecting means for selecting one rack to be judged in the rack list; rack space judging means for judging whether rack space of the selected rack satisfies the predetermined requirement; rack total power judging means for judging whether rack total power of the selected rack satisfies the predetermined requirement; and rack unit power density judging means for judging whether rack unit power density of the selected rack satisfies the predetermined requirement; wherein, if one of free space, rack total power, or rack unit power density of the selected rack does not satisfy the predetermined requirement, the rack selecting means reselects one rack to be judged from the rack list, then the rack space judging means, the rack total power judging means and the rack unit power density judging means judge whether the reselected rack satisfies the predetermined requirement respectively.

In another preferred embodiment, the judging means 502 of FIG. 5 comprises (not shown in FIG. 5): candidate rack list forming means for ordering available racks in the data center by space utilization to form a candidate rack list; rack selecting means for selecting a rack currently has the highest space utilization from the candidate rack list; rack space judging means for judging whether rack space of the selected rack satisfies the predetermined requirement; rack total power judging means for judging whether rack total power of the rack satisfies the predetermined requirement; and rack unit power density judging means for judging whether rack unit power density of the selected rack satisfies the predetermined requirement; wherein, if one of rack space, rack total power, or rack unit power density of the selected rack does not satisfy the predetermined requirement, the candidate rack list forming means deletes that rack from the candidate rack list, the rack selecting means reselects a rack currently has the highest space utilization from the candidate rack list, then the rack space judging means, the rack total power judging means and the rack unit power density judging means judge whether the reselected rack satisfies the predetermined requirement respectively.

In one embodiment, predetermined requirement for rack total power includes: total power of all devices in a rack can not exceed maximum allowable total power of that rack, the maximum allowable total power of a rack is a minimum value between power defined by rack powering load and power defined by rack cooling capability. The power defined by rack cooling capability may be obtained by estimation, for example, it may be estimated according to cooling capability of respective region planned and implemented by the data center; or be estimated according to historical monitoring data, including total power of respective rack during actual operation and temperature around respective rack; or even may be estimated according to number of air outlet floor, ventilation quantity, air pressure, computational fluid dynamics simulated result at air inlet of cold channel of respective rack measured by IBM mobile measurement technology.

In one embodiment, predetermined requirement for rack unit power density may be: unit power density of a rack into which the device is added approaches a predetermined unit power density value, the predetermined unit power density value may be unit power density of overall data center; or unit power density of certain cooling region; or may also be a specified value.

In one embodiment, predetermined requirement of rack unit power density may be one of the following: (1) unit power density of the device is larger than a predetermined unit power density value, and unit power density of the selected rack is smaller than the predetermined unit power density value; (2) unit power density of the device is smaller than a predetermined unit power density value, and unit power density of the selected rack is larger than the predetermined unit power density value. However, in other cases, for example, if unit power density of the device is larger than a predetermined unit power density value, and unit power density of the selected rack is also larger than the predetermined unit power density value, then it is considered that the rack does not satisfy predetermined requirement of rack unit power density; alternatively, if unit power density of the device is smaller than a predetermined unit power density value, and unit power density of the selected rack is also smaller than the predetermined unit power density value, then it is also considered that the rack does not satisfy predetermined requirement of rack unit power density etc.

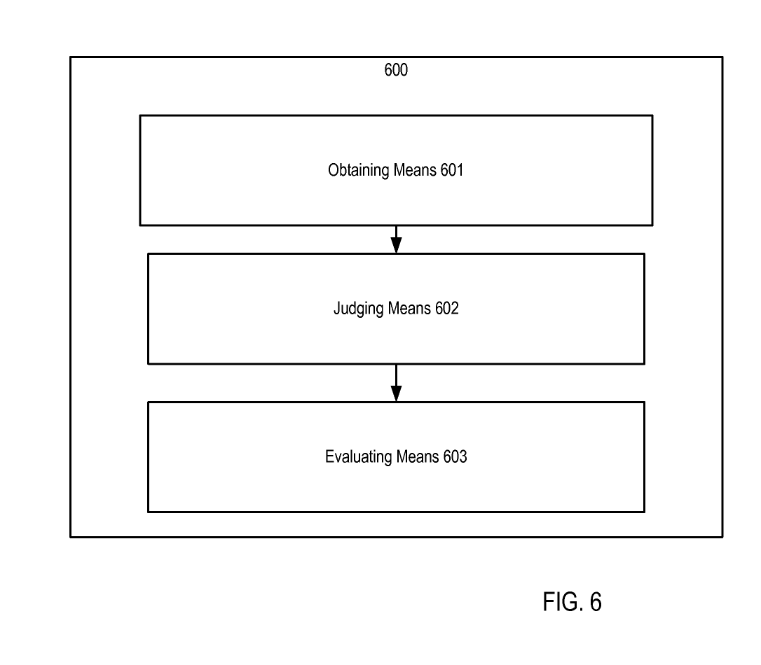

FIG. 6 sets forth a block diagram of an example system 600 for evaluating in a data center whether there is risk when a device is installed in a current rack, block diagram of the system is shown in FIG. 6, the system comprising: obtaining means 601 for obtaining physical size and power of the device; judging means 602 for judging whether rack total power and rack unit power density satisfy a predetermined requirement when the device is in the current rack according to physical size and power of the device; and evaluating means 603 for evaluating that there is risk when the device is installed in the current rack, if any one of rack total power or rack unit power density does not satisfy the predetermined requirement.

Although exemplary embodiments of the invention have been described with reference to appended drawings, it should be appreciated that the present invention is not limited to these precise embodiments, and those skilled in the art can make various changes and modifications to the embodiments without departing from the scope and spirit of the present invention. All these changes and modifications are intended to be encompassed in the scope of the present invention defined by the appended claims.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Further, each block of the flowchart and/or block diagram, and combinations of blocks in the flowchart and/or block diagram, can be implemented by computer program instructions. These computer program instructions may be provided to a processor of a general-purpose computer, a special-purpose computer or other programmable data processing apparatus to produce a machine, such that the instructions which execute on the computer or other programmable data processing apparatus create means for implementing the functions/operations specified in the block(s) of the flowchart and/or block diagram.

These computer program instructions may also be stored in a computer-readable medium that can direct a computer or other programmable data processing apparatus to function in a particular manner, such that the instructions stored in the computer-readable medium produce an article of manufacture including instruction means which implement the functions/operations specified in the block(s) of the flowchart and/or block diagram.

The computer program instructions may also be loaded into a computer or other programmable data processing apparatus to perform a sequence of operational steps on the computer or other programmable data processing apparatus so as to produce computer implemented process, such that the instructions which execute on the computer or other programmable data processing apparatus will provide process for implementing the functions/operations specified in the block(s) of the flowchart and/or block diagram.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of selecting an installation rack for a device in a data center, the method comprising:
obtaining physical size and power of the device;
judging, according to the physical size and power of the device, whether rack space, rack total power, and rack unit power density of a rack in the data center satisfy predetermined requirement after the device is added into the rack; and
selecting a rack that satisfies the predetermined requirement as an installation rack.

2. The method of to claim 1, wherein the power of the device comprises one of the following:
rated power of the device;
average power during actual operation; and
maximum power during actual operation.

3. The method of claim 2, further comprising:
obtaining the average power during actual operation and the maximum power during actual operation of the device, including one of:
obtaining the average power from historical monitoring data;
obtaining the average power from historical monitoring data of a device with same type and same configuration; and
obtaining the average power from the device's rated power.

4. The method of claim 1, wherein the judging whether rack space, rack total power, and rack unit power density of a rack in the data center satisfy predetermined requirement after the device is added into the rack further comprises:
obtaining rack list in the data center;
selecting one rack to be judged in the rack list;
judging whether rack space of the rack satisfies the predetermined requirement, and returning to the step of selecting one rack to be judged in the rack list if rack space of the rack does not satisfy the predetermined requirement;
judging whether rack total power of the rack satisfies the predetermined requirement, and returning to the step of selecting one rack to be judged in the rack list if rack total power of the rack does not satisfy the predetermined requirement; and
judging whether rack unit power density of the rack satisfies the predetermined requirement, and returning to the step of selecting one rack to be judged in the rack list if rack unit power density of the rack does not satisfy the predetermined requirement.

5. The method of claim 1, wherein the judging step comprises:
ordering available racks in the data center by space utilization to form a candidate rack list;
selecting a rack currently has the highest space utilization from the candidate rack list;
judging whether rack space of the selected rack satisfies the predetermined requirement, deleting the rack from the candidate rack list and returning to the step of selecting a rack currently has the highest space utilization from the candidate rack list if rack space of the rack does not satisfy the predetermined requirement;
judging whether rack total power of the rack satisfies the predetermined requirement, deleting the rack from the candidate rack list and returning to the step of selecting a rack currently has the highest space utilization from the candidate rack list if rack total power of the rack does not satisfy the predetermined requirement; and
judging whether rack unit power density of the rack satisfies the predetermined requirement, deleting the rack from the candidate rack list and returning to the step of selecting a rack currently has the highest space utilization from the candidate rack list if rack unit power density of the rack does not satisfy the predetermined requirement.

6. The method of claim 5, wherein the predetermined requirement for rack total power comprises:
total power of all devices in a rack can not exceed maximum allowable total power of that rack, the maximum allowable total power of the rack
comprising a minimum value selected from power defined by rack powering load and power defined by rack cooling capability.

7. The method of claim 6, wherein the power defined by rack cooling capability comprises an estimated value, the estimation comprising one of:
estimating the rack cooling capability in dependence upon a cooling capability of a region planned and implemented in the data center;
estimating the rack cooling capability in dependence upon historical monitoring data that includes total power of the rack during actual operation and temperature around the rack; and
estimating the rack cooling capability in dependence upon a number of air outlets in a floor, ventilation quantity, air pressure, computational fluid dynamics simulated result at an air inlet of a cold channel of the rack measured.

8. The method of claim 5, wherein the predetermined requirement for unit power density of a rack comprises:
a unit power density of a rack into which the device is added that comprises a value in a range of predetermined unit power density values, where each predetermined unit power density value comprises one of:
a unit power density of the whole data center;
a unit power density of certain cooling region; and
a specified value.

9. The method claim 5, wherein the predetermined requirement for unit power density of a rack comprises one of:
unit power density of the device is greater than a predetermined unit power density value, and unit power density of the selected rack is less than the predetermined unit power density value; and
unit power density of the device is less than a predetermined unit power density value, and unit power density of the selected rack is greater than the predetermined unit power density value.

10. A method of evaluating risk in a data center upon device installation in a rack, comprising:
obtaining physical size and power of the device;
judging whether rack total power, and rack unit power density satisfy a predetermined requirement when the device is in the current rack according to physical size and power of the device; and
determining that there is risk when the device is installed in the current rack, if any one of rack total power or rack unit power density does not satisfy the predetermined requirement.

11. A system for selecting an installation rack for a device in a data center, the system comprising:
obtaining means for obtaining physical size and power of the device;
judging means for judging, according to the physical size and power of the device, whether rack space, rack total power, and rack unit power density of a rack in the data center satisfy predetermined requirement after the device is added into the rack; and
selecting means for selecting a rack that satisfies the predetermined requirement as an installation rack.

12. The system of claim 11, wherein the power of the device comprises one of the following:
rated power of the device;
average power during actual operation; and
maximum power during actual operation.

13. The system of claim 12, wherein the obtaining means further comprises means for obtaining average power during actual operation and the maximum power during actual operation of the device, including one of:
obtaining the average power from historical monitoring data;
obtaining the average power from historical monitoring data of a device with same type and same configuration; and
obtaining the average power from the device's rated power.

14. The system of claim 11, wherein the judging means comprises:
rack list obtaining means for obtaining rack list in the data center;
rack selecting means for selecting one rack to be judged in the rack list;
rack space judging means for judging whether rack space of the selected rack satisfies the predetermined requirement;
rack total power judging means for judging whether rack total power of the selected rack satisfies the predetermined requirement; and
rack unit power density judging means for judging whether rack unit power density of the selected rack satisfies the predetermined requirement;
wherein, if one of free space, rack total power, or rack unit power density of the selected rack does not satisfy the predetermined requirement, the rack selecting means reselects one rack to be judged from the rack list, then the rack space judging means, the rack total power judging means and the rack unit power density judging means judge whether the reselected rack satisfies the predetermined requirement respectively.

15. The system of claim 11, wherein the judging means comprises:
candidate rack list forming means for ordering available racks in the data center by space utilization to form a candidate rack list;
rack selecting means for selecting a rack currently has the highest space utilization from the candidate rack list;
rack space judging means for judging whether rack space of the selected rack satisfies the predetermined requirement;
rack total power judging means for judging whether rack total power of the rack satisfies the predetermined requirement; and
rack unit power density judging means for judging whether rack unit power density of the selected rack satisfies the predetermined requirement;
wherein, if one of rack space, rack total power, or rack unit power density of the selected rack does not satisfy the predetermined requirement, the candidate rack list forming means deletes that rack from the candidate rack list, the rack selecting means reselects a rack currently has the highest space utilization from the candidate rack list, then the rack space judging means, the rack total power judging means and the rack unit power density judging means judge whether the reselected rack satisfies the predetermined requirement respectively.

16. The system of claim 15, wherein the predetermined requirement for rack total power is: total power of all devices in a rack can not exceed maximum allowable total power of that rack, the maximum allowable total power of the rack comprising a minimum value selected from power defined by rack powering load and power defined by rack cooling capability.

17. The system of claim 16, wherein the power defined by rack cooling capability comprises an estimated value, the estimation comprising one of:
estimating the rack cooling capability in dependence upon a cooling capability of a region planned and implemented in the data center;
estimating the rack cooling capability in dependence upon historical monitoring data that includes total power of the rack during actual operation and temperature around the rack; and
estimating the rack cooling capability in dependence upon a number of air outlets in a floor, ventilation quantity, air pressure, computational fluid dynamics simulated result at an air inlet of a cold channel of the rack measured

18. The system of claim 15, wherein the predetermined requirement for unit power density of a rack comprises:
a unit power density of a rack into which the device is added that comprises a value in a range of predetermined unit power density values, where each predetermined unit power density value comprises one of:
a unit power density of the whole data center;
a unit power density of certain cooling region; and
a specified value.

19. The system of claim 15, wherein the predetermined requirement for unit power density of a rack comprises one of:
unit power density of the device is greater than a predetermined unit power density value, and unit power density of the selected rack is less than the predetermined unit power density value; and
unit power density of the device is less than a predetermined unit power density value, and unit power density of the selected rack is greater than the
predetermined unit power density value.

20. A system for evaluating risk in a data center upon device installation in a rack, comprising:
obtaining means for obtaining physical size and power of the device;
judging means for judging whether rack total power and rack unit power density satisfy a predetermined requirement when the device is in the current rack according to physical size and power of the device; and
evaluating means for determining that there is risk when the device is installed in the current rack, if any one of rack total power or rack unit power density does not satisfy the predetermined requirement.
